(19) United States
(12) Patent Application Publication
(10) Pub. No.: US 2010/0108448 A1
(43) Pub. Date: May 6, 2010

(54) Locking wheel chock

(76) Inventor: Philip W. Wyers, Centennial, CO (US)

Correspondence Address: Philip W. Wyers, 14705 E. Aberdeen Avenue, Centennial, CO, 80016, US

(21) Appl. No.: 12/290,439

(22) Filed: Oct. 30, 2008

(51) Int. Cl. B60T 3/00; E05B 35/00; B60R 25/00

(52) U.S. Cl. 188/32; 70/344; 70/226

(57) ABSTRACT

A locking wheel device designed to prevent the unauthorized movement and or roll away of a wheeled vehicle or trailer by locking onto a wheel and having a configuration such that the device also serves to chock the wheel when in the locked on position. A locking wheel chock device which includes two similar matching arms with both a male and female tube attached to one end to allow for the telescopic engagement of said arms. The female tube having attached a lock assembly for locking said arms in a fixed position. Further, the female tube portion has attached to its lower edge, which is closest to the ground, means for contacting the ground in a binding fashion so as to prevent forward rolling movement of the wheel.

### FIELD OF THE INVENTION

The present invention relates generally to various wheel chocking apparatus designed to be secured to motor vehicles and or trailer wheels to prevent movement and theft. Devices in the field at present range in complexity from elaborate government style “Denver Boot” (U.S. Pat. No. 2,960,857) type systems to simpler yet lacking in function locking chock type devices like those found in U.S. Pat. No. 3,907,072. These mentioned devices, and all in between fail to adequately address the combined need for strength, convenience and practical security.

### BACKGROUND ART AND FIELD OF THE INVENTION

The present invention relates to a dramatically improved and simplified embodiment of a lockable wheel chocking device that can be installed quickly and easily to a motor vehicle, unattended trailer, aircraft, or ATV, to name a few. The present invention utilizes non-obvious geometric principles to drastically minimize the size and amount of materials required to effectively chock and securely lock a trailer or vehicle.

The present invention is further designed for convenient handling and storage so as to increase the likelihood that the device will be used regularly and consistently. As a practical matter, any and all towed trailers need to have at least one wheel chocked before decoupling from the tow vehicle to prevent it from surging forward or backward possibly causing bodily injury, or damage to the tow vehicle or surrounding property. The present invention is the first of its kind to offer a truly practical, convenient solution to the mandatory need to chock a trailer tire, while at the same time providing a safety and anti-theft solution by preventing the accidental, or purposeful removal of the wheel chock.

Prior devices, some of which were mentioned above, and as mentioned here have numerous shortcomings. These prior devices have proposed various solutions relating to the immobilizing of vehicles and trailers with cumbersome locking devices that lack the general strength required, are heavy, or are overly complicated and impractical to use on a regular basis. One such example found in U.S. Pat. No. 4,804,070 issued Feb. 14, 1989 to Bohler. The Bohler patent, a complex locking wheel chock is taught in order to immobilize a vehicle wheel that utilizes a vast number of parts and has a frail locking means. These fatal flaws make it disadvantageous for any real practical use or meaningful commercial application. Another example of a vehicle immobilizing device is found in U.S. Pat. No. 4,649,724 issued Mar. 17, 1987 to Raine. This device suffers the same drawbacks and limitations as that of Bohler. Still yet another device is found in U.S. Pat. No. 5,137,121 issued Aug. 11, 1992 to Leonard. Leonard's device is very similar to that of U.S. Pat. No. 3,907,072 issued Sep. 23, 1975 to Shafer. It too suffers the same drawbacks found in that of the Shafer. Both devices are bulky and lack the innovative design necessary to achieve a practical combination of usability and strength with the fewest amount of required parts. Yet still another device as shown in U.S. Pat. No. 5,873,275 issued Feb. 23, 1999 to Lukich, Shows a wheel locking device having an elongated handle attached to the middle of the straight portion between the locking arms. While this device approaches a usable size, its cumbersome locking mechanism makes it expensive to manufacture as well as difficult to and slow to install. Further the elongated center mounted handle ads bulk and a lever arm that can be use to defeat the device. Most importantly, this device lacks the utility of the present invention due to the fact that the long handle prevents the device from being used as reliable wheel chock. The handles length causes it to slide with unpredictable behavior when rotational forces are applied by a wheel. These mentioned drawbacks of the prior art, together with the difficulty in retailing these products due to their large size, weight, and general bulk, make them difficult to package and impractical to display in a retail environment. For these reasons, all the known prior art have never achieved any real commercial success.

Due to the draw backs noted in the prior known art, there remains a strong need for an improved locking wheel chock device that is easy and functional to use both as a security anti-theft device and as a useful and reliable wheel chocking device. The device detailed in the present invention not only accomplishes these long felt needs, but further provides the major benefits of being easy, and inexpensive to manufacture, along with being cost effective to ship, and display easily at the retail level.

### SUMMARY OF THE INVENTION

It is now proposed, in accordance with the present invention, to eliminate the known wheel lock drawbacks found in the existing prior art, by providing a locking wheel chock that is not only strong and secure that functions flawlessly as both a security anti-theft device, but also as a safe and efficient wheel chock.

It is another object of the invention to provide a product that is easy to store and use on a regular basis by the public, and is further easy to ship, and display at the retail level. Still further it is an important object of the present invention to provide a product that is inexpensive and easy to manufacture.

These and other objects of the present invention will become more readily appreciated and understood from consideration of the following detailed descriptions of the exemplary embodiment of the present invention when taken together with the accompanying drawings, in which:

### BRIEF DESCRIPTION OF THE DRAWINGS

Details of this invention are described in connection with the accompanying drawings where like parts bear similar reference numerals in which:

FIG. 1 is a perspective view of the preferred embodiment, shown attached to a trailer wheel in the locked and chocked position.

FIG. 2 is a fully expanded perspective view that shows the male and female structural inter-connecting relationship between the two components that form the clamp locking chock device.

FIG. 3 is an exploded view of locking mechanism found in FIG. 2.

FIG. 4 is perspective view showing the locking wheel chock in the locked position.

FIG. 5 is a detailed cross section of the push button cross bolt lock system.

FIG. 6 and FIG. 6A is a detailed cross section of an alternative embodiment of the push button cross bolt lock system that further incorporates a spring ball to assist in the positioning of the cross bolt for locking purposes.

FIG. 7 is a front view of the locking wheel chock in the fully closed position.

FIG. 8 is a side view of the device showing the relative angle of the chocking edge.

### DETAILED DESCRIPTION OF THE EXEMPLARY EMBODIMENT

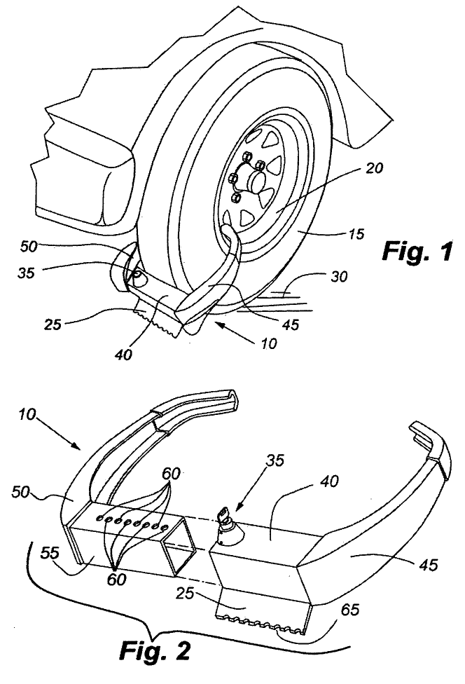

Referring more particularly to the drawings, wherein like numbers refer to like parts, FIGS. 1 shows the locking wheel chock in the locked and chocked position around a trailer tire 15 and wheel 20. FIG. 1 further shows the chocking engagement of the blade 25 with the ground 30. The relative position of the locking mechanism 35 is shown positioned on the upper surface of the female housing 40 which is attached to a first locking arm 45, which is opposite the second locking arm 50.

As shown in FIG. 2 which shows a perspective view of the locking wheel chock 10 in a separated and unlocked state. This view details the male lock housing 55 and shows lock positioning holes 60 that telescopically mate with the female housing and allow for incremental locking engagement with the lock mechanism 35 positioned on the upper surface of the female housing 40. FIG. 2 further shows the first locking arm which is attached to the female housing, and the second locking arm 50 which is attached to the male housing. The female housing 40 has on its lower surface an attached blade 25 that can contact the ground at a multitude of angles for chocking engagement. Blade 25 has on its ground contacting surface serrations 65 to serve in creating greater friction with the ground surface.

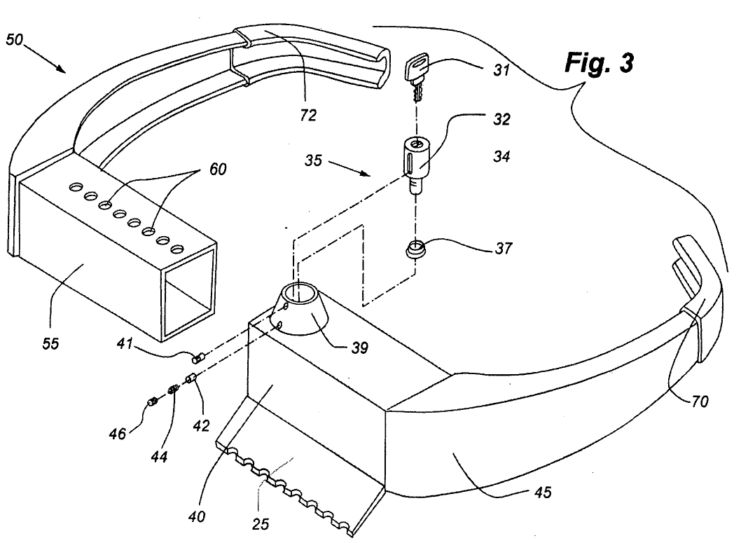

FIG. 3 Shows an exploded view of the locking mechanism 35 with key 31, lock core 32, cross bolt 34, pop up spring 37, lock housing 39, lock core retention pin 41, cross bolt pin 42, cross bolt pin spring 44, and retention pin 46. FIG. 3 further shows a protective coating 70 on first arm 45, and protective coating 72 on second arm 50.

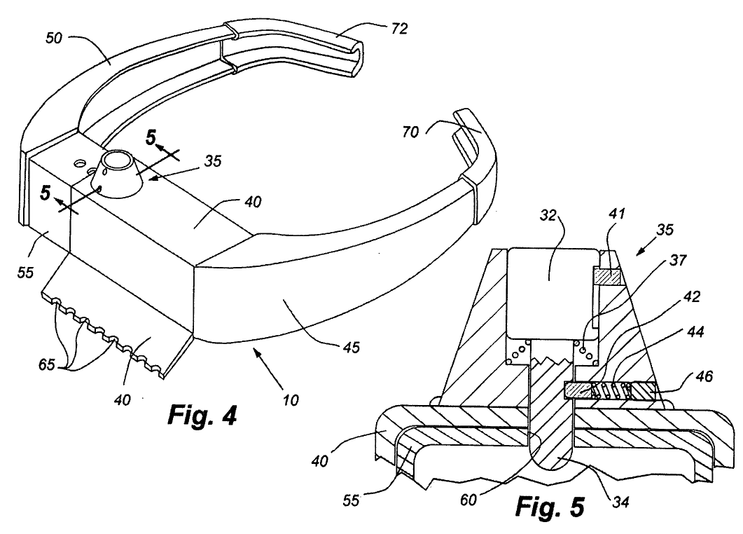

FIG. 4 shows locking wheel chock 10 in a partially closed and locked position.

FIG. 5 shows a detailed cross section of the locking mechanism 35 in the Locked position with lock core 32 pushed down so as to push the cross bolt 34 through the cross section of the female housing 40 and through one of the predetermined positioning holes 60 of the male housing 55.

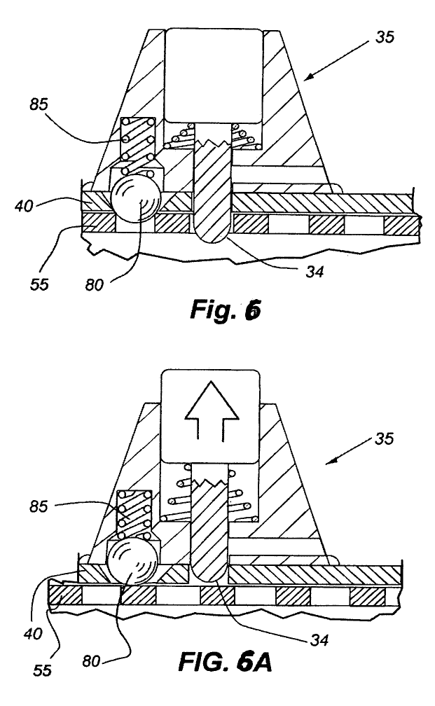

FIG. 6 & FIG. 6A shows a detailed cross section of an alternative embodiment of the locking mechanism 35, which has included in the housing 39 a positioning ball 80, that is pushed outward by a spring 85, so as to partially engage the position holes 60 of the male housing which assists in the alignment of the cross bolt 34 with the position holes 60 on the male housing 55.

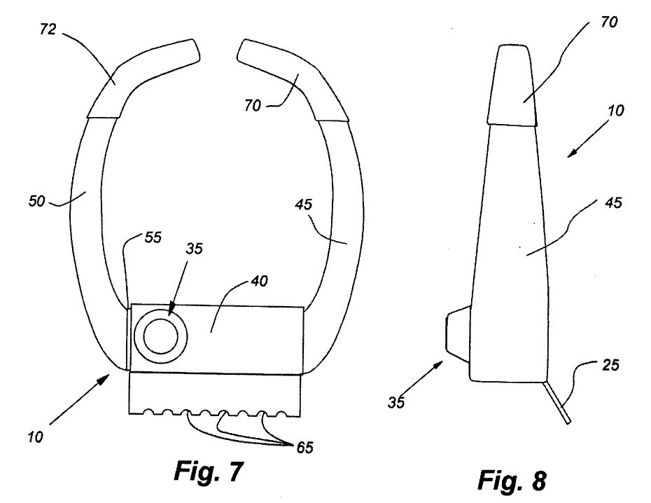

FIG. 7 shows a front view of the locking wheel chock 10 in the fully closed position.

FIG. 8 shows side view of the locking wheel chock 10, and illustrates the relative preferred position of the blade 25 which is attached to the lower portion of the female housing 40.

Although the present invention has been described with a certain degree of particularity, it is understood that the present disclosure has been made by way of example and that changes in the details of the preferred and modified forms of the inventions structure may be made without departing from the inventions spirit and scope thereof. Additionally it should be appreciated that the present invention is defined by the following claims construed in light of the prior art so that modifications or changes may be made to the exemplary embodiment of the present invention without departing from the inventive concepts contained herein.

I claim:

1. A lockable wheel device comprising:
A first and second member capable of telescopic engagement so as to be incrementally lockable to predetermined widths to accommodate variable inner dimensions;
said first member having a generally straight portion of an adequate predetermined length, and a first arm portion of a predetermined length formed or attached generally perpendicular to said first end of straight portion and tip of said first arm having an inward leaning orientation of a predetermined length that is less than perpendicular;
said second member having a generally straight portion, having on it, a selected surface,with a sequence of engagable penetrations, and is sized to slidably mate in a male relationship with said open second end of the straight female portion of first member, and having a second arm portion of a predetermined length formed or attached generally perpendicular to said first end of second straight portion, said second arm having an inward leaning orientation at its tip of a predetermined length that is less than perpendicular;
said first member further having on a predetermined length of the lower side of said generally straight female portion, means for engaging the ground so as to increase friction or binding with the ground surface when wheel pressure is applied;
a locking mechanism positioned for access on the outer generally straight surface of said first member having means to lockably engage penetrations of the generally straight portion of said second male member when telescopically engaged with said first member.

2. A lockable wheel device according to claim 1 wherein said locking mechanism is key operable.

3. A lockable wheel device according to claim 2 wherein said locking mechanism is a push button system with a cross bolt that passes into penetrations of said second member.

4. A lockable wheel device according to claim 1 wherein said means for engaging the ground is one or more protrusions of adequate size and length and having a predetermined attachment angle which creates increasing geometric pressure to the ground when pressure is applied by the wheel.

5. A lockable wheel device according to claim 1 wherein said means for engaging the ground is a horizontally attached piece of material of a predetermined size and shape attached at a predetermined angle that forms an edge and increases pressure to the ground in a cam like fashion when increased wheel pressure is applied.

6. A locking wheel device according to claim 1 wherein said means for contacting the ground is a blade of material with one or more tooth like projection on the ground contacting edge.

7. A locking wheel chock, comprising:
(A) a first locking arm including
(1) an elongated generally straight portion,
(2) an arm portion affixed or bent perpendicular at a first end of said generally straight portion, and having at a predetermined distance a less than perpendicular portion affixed or bent at its distal end, and
(3) an open end at the second end of said generally straight portion, and
(4) a means for creating friction or interference along the bottom ground facing edge of the generally straight portion, and further having
(5) a locking mechanism located towards the open second end on an accessible surface;
(B) a second locking arm including
(1) an elongated generally straight portion,
(2) an arm portion affixed or bent perpendicular at a first end of said generally straight portion, and having at a predetermined distance a less than perpendicular portion affixed or bent at its distal end, and
(3) the generally straight portion is sized in a male relation to telescopically engage the slightly larger female open end portion of the second end of the generally straight portion of the first locking arm, and
(4) having a sequence of through bores on the generally straight portion, that align to lockably engage with the lock mechanism of said first locking arm.

8. A locking wheel chock according to claim 7 wherein said locking mechanism is key operable

9. a locking mechanism according to claim 8 wherein the lock core pushes downward to engage a shear pin through one of the bore holes of the second locking arm.

10. a locking wheel chock according to claim 7 wherein the means for creating friction on the ground facing surface for the first locking arm is a length of material forming an edge and is attached at a predetermined angle and sized so as to create a cam binding effect that increases friction as more pressure is applied.

11. a locking wheel chock according to claim 10 wherein the said edge is a metal blade of adequate thickness with one of more raised teeth on its bottom edge to better dig into the ground or contact surface.

12. a locking wheel chock according to claim 7 wherein the means for creating friction on the ground facing surface for the first locking arm is one or more protrusions creating an uneven surface and such protrusions are located at a predetermined angle and sized so as to create a cam binding effect that increases friction as more pressure is applied.

13. A locking mechanism according to claim 9 having an attached housing containing a spring positioning ball to assist in the alignment of the shear pin when moving from an unlocked to locked state.

14. A method for locking and chocking a vehicle wheel with a clamping device, comprising in any order:
(A) telescopically joining a first and second arm structure that have a generally straight telescopic portion connecting generally inwardly curved shaped arms around a vehicle wheel;
(B) closing and pressing the first and second arm structures tightly against the wheel sidewalls to a selected position so the telescopic straight portion of the first arm structure makes contact with the ground;
(C) lockably securing the first and second arm structures to define a locked state wherein the wheel chock cannot be disengaged from said vehicle wheel.

15. A method according to claim 14 wherein said generally straight portion of first arm structure has attached to its lower ground contacting surface one or more projections that contact the ground at a predetermined angle creating a binding cam chocking effect when wheel pressure is applied.

16. A method according to claim 14 wherein said generally straight portion of first arm structure has attached to its lower ground contacting surface a horizontal edge for contacting the ground at a predetermined angle creating a binding chocking effect.
